(19) United States
(12) Patent Application Publication
(10) Pub. No.: US 2014/0042201 A1
(43) Pub. Date: Feb. 13, 2014

(54) MOUNTING FOR A TWO-WHEELER ACCESSORY

(71) Applicant: ABUS August Bremicker Sohne KG, Wetter-Volmarstein (DE)

(72) Inventors: Bernd WEIERSHAUSEN, Rehe (DE); Andeas KIPPING, Brunken (DE)

(73) Assignee: ABUS August Bremicker Sohne KG, Wetter-Volmarstein (DE)

(21) Appl. No.: 13/963,808

(22) Filed: Aug. 9, 2013

(30) Foreign Application Priority Data
Aug. 9, 2012 (DE) 102012214211.8

(51) Int. Cl. B62J 11/00

(52) U.S. Cl. CPC B62J 11/00
USPC 224/414

(57) ABSTRACT

A mounting for a two-wheeler accessory such as for a two-wheeler lock, for a water bottle or the like has a holder and a fastening strap. The holder comprises a support section for resting on a tube section of a two-wheeler and a receiving section for receiving the two-wheeler accessory. The fastening strap fastens the holder, the tube section and the two-wheeler accessory to one another. A first end section of the fastening strap extends in the region of the receiving section of the holder, an intermediate section of the fastening strap extends in the region of the support section and a second end section of the fastening strap in turn extends in the region of the receiving section. An operative section of the fastening strap is provided along a part of the first end section and an associated operative counter-section is provided along a part of the second end section of the fastening strap.

### BACKGROUND OF THE INVENTION

The invention relates to a mounting for a two-wheeler accessory such as for a two-wheeler lock, for a water bottle or the like.

Such a mounting is required to secure the respective accessory to the two-wheeler permanently or temporarily—for example during a specific journey. Such a mounting is usually secured to a tube section of the frame, of the bicycle luggage carrier or of the seat tube of the two-wheeler. A mounting for a two-wheeler is known, for example, from document DE 20 2005 013 390 U1.

A fastening device of variable length can be used to be able to adapt a mounting flexibly to different kinds and diameters of tube sections of the two-wheeler and to be able also to secure accessories of different size to the two-wheeler. For this purpose, the mounting can have a holder and a fastening strap, wherein the holder comprises a support section for resting on the tube section of the two-wheeler and a receiving section for receiving the two-wheeler accessory. The fastening strap is led around the tube section of the two-wheeler and around the two-wheeler accessory and the fastening strap has at least one operative section and an associated operative counter-section which forms a releasable operative connection with the operative section to be able to define the position of the fastening strap in a variable manner.

Such a mounting is described in the document U.S. Pat. No. 5,833,188, wherein here a two-fold deflection of the fastening strap at a common buckle is shown. The buckle is provided at a first end section of the fastening strap, with first an intermediate section of the fastening strap being deflected at a first eyelet of the buckle and with a second end section of the fastening strap being deflected at a second eyelet of the buckle. An operative hook and loop section and directly adjacent hereto an associated hook and loop counter-section are provided at the second end section of the fastening strap and come to lie on one another at the second eyelet due to the deflection. The second eyelet engages in an intermediate space between the two hook and loop sections at the second end section of the fastening strap. It is a problem with such a mounting that as the diameter of the tube section of the two-wheeler which is engaged around and/or of the two-wheeler accessory which is engaged around becomes increasingly larger, an increasing relative displacement occurs between the operative hook and loop section and the associated hook and loop counter-section which directly results in a smaller degree of overlap of the two hook and loop sections due to the deflection of the fastening strap at a point between the two hook and loop sections. The deflected operative hook and loop section or hook and loop counter-section can even come to lie on itself. The hook and loop connection hereby becomes less reliable.

### BRIEF SUMMARY OF THE INVENTION

It is an object of the invention to provide a mounting for a two-wheeler accessory which also allows a reliable and nevertheless easy to release securing for tube sections of different diameters and/or for accessories of different diameters.

This object is satisfied by a mounting having the features of claim 1 and in particular in that a first end section of the fastening strap extends in the region of the receiving section of the holder, an intermediate section of the fastening strap extends in the region of the support section of the holder and a second end section of the fastening strap in turn extends in the region of the receiving section of the holder, wherein the operative section of the fastening strap is provided along a part of the first end section and the associated operative counter-section is provided along a part of the second end section of the fastening strap.

The mounting therefore comprises a holder which receives a two-wheeler accessory and which can be secured to a tube section of a two-wheeler by means of a fastening strap. The fastening strap is a flexible strip at which at least one operative section and at least one associated operative counter-section are provided. The operative section and the associated operative counter-section of the fastening strap are arranged at two mutually opposite end sections of the fastening strap and not adjacent to one another, for instance. The two end sections of the fastening strap are separated by a so-called intermediate section. The fastening of the accessory to the tube section of the two-wheeler ultimately takes place due to the operative connection between the two end sections of the fastening strap which engages around the tube section and/or the accessory. A reciprocal pressing force onto the tube section and onto the accessory can thus be produced by displacing the first end section relative to the second end section of the fastening strap. The first end section and the second end section of the fastening strap can be fixed relative to one another in this position by means of the operative section and the associated operative counter-section.

The position of the first end section of the fastening strap with the operative section provided thereon is fixed unchangeably and in particular does not vary on a use of the mounting for different sizes of the tube section of the two-wheeler or of the received two-wheeler accessory. Only the position of the operative counter-section can vary relative to the operative section. This has the advantage that even on a use for different sizes (in particular diameters) of the tube section and of the accessory a high degree of overlap is ensured between the operative section and the operative counter-section, i.e. a reliable operative connection is formed. It is only necessary that the operative counter-section of the fastening strap is long enough to completely cover the operative section in every possible position relative to the operative section. This is, however, not a problem since no deflection of the fastening strap has to take place in the direct environment of the operative counter-section (as is, for example, the case at the buckle in accordance with document U.S. Pat. No. 5,833,188).

In another respect, the mounting is particularly suitable for an embodiment in which (as in the document U.S. Pat. No. 5,833,188) the receiving section of the holder is open along an axis parallel to the longitudinal axis of the tube section of the two-wheeler and the receiving section of the holder is also circumferentially open to allow the reception in a flexible manner of accessories of different size or of different shape.

It must still be noted in connection with the invention that the named receiving section and the support section of the holder can be directly adjacent to one another or can merge into one another. For example, in the case of a C shape or U shape of the receiving section, a limb or the base of the C shape or of the U shape can directly form the support section of the holder.

It must further be noted that the named operative section of the fastening strap can be formed by an operative hook and loop section and the associated operative counter-section of the fastening strap can be formed by an operative hook and loop counter-section, wherein the hook and loop section and the associated hook and loop counter-section form a releasable hook and loop connection. In this respect, any desired type of hook and loop connection can be provided, for example in accordance with the barbed hook/loop principle or the mushroom head/mushroom head principle. However, a hook and loop connection is not necessarily required. For example, a releasable operative connection between the first end section and the second end section of the fastening strap can also be formed by a press button or a rotatable toggle (=operative section) and an arrangement of a plurality of associated eyelets (=operative counter-section).

### DETAILED DESCRIPTION OF THE INVENTION

It is advantageous if the two-wheeler accessory, the holder and the tube section of the two-wheeler are engaged around by the fastening strap in a plane perpendicular to the longitudinal axis of the tube section. A high tension force can thereby be built up in the fastening strap to achieve a high fixing effect.

The receiving section of the holder with respect to the named plane perpendicular to the axis of the tube section can, as already mentioned, be circumferentially open and have a C shape or U shape, for example. In this case, the two limbs of the C shape or of the U shape can already exert a specific holding force on the received accessory due to their own elasticity.

It is particularly advantageous if the receiving section of the holder has a U shape or a C shape which is laterally open with respect to an imaginary connection line between the center of the tube section of the two-wheeler and the center of the received two-wheeler accessory. A particularly good force transmission from the fastening strap to the accessory inserted into the receiving section is hereby possible to hold the accessory securely.

The named fastening strap can be elastic (in particular rubber elastic) sectionally or over its total length in the longitudinal direction. Particularly good permanently effective tension forces can hereby be produced to fasten the holder, the tube section of the two-wheeler and the two-wheeler accessory reliably to one another.

The first end section of the fastening strap advantageously has an anchor at its open end by means of which the fastening strap can be anchored in an opening at the holder in a particularly simple manner. An anchorage at the holder has the advantage that a tension force of the fastening strap can be transmitted to the holder, in particular without the necessity of an additional component (e.g. a separate eyelet). Such an anchor can be realized, for example, by a thickened proton of the fastening strap, namely in that the fastening strap is folded several times and sewn. Alternatively, however, a separate anchor element can be secured to the first end section of the fastening strap, for example a pin or a platelet sewn to the fastening strap or surrounded by the fastening strap.

The following extent of the fastening strap is furthermore particularly advantageous: The first end section of the fastening strap can be led along an outer surface of the receiving section of the holder. The intermediate section of the fastening strap adjoining the first end section can then be led around the tube section of the two-wheeler on a use of the mounting in accordance with its intended purpose such that the tube section of the two-wheeler is pressed toward the support section of the holder by exertion of a pushing force onto the fastening strap. The second end section of the fastening strap which in turn adjoins the intermediate section can ultimately be led along the named outer surface of the receiving section of the holder such that the operative counter-section of the fastening strap comes to lie on the associated operative section of the fastening strap. A pushing force exerted onto the second end section of the fastening strap can thus simultaneously act on the receiving section of the holder and on the accessory received therein as well as on the tube section of the two-wheeler. It is of advantage in this respect if the first end section of the fastening strap is anchored in the holder, in particular in the receiving section.

In accordance with an advantageous embodiment, the holder has a deflection element, such as a hoop, which projects from, i.e. is spaced apart from, the named support section for the receiving section of the holder. The deflection element can thus be adapted to receive a loop formed by the intermediate section of the fastening strap, while the fastening strap engages around the tube section of the two-wheeler. A deflection of the fastening strap in the region of the tube section of the two-wheeler is therefore hereby made possible by an integral section of the holder. A separate eyelet is not necessary.

In this embodiment, the fastening strap can have a further operative section and an associated further operative counter-section which forms a further releasable operative connection with the further operative section. This further operative connection can fix the loop of the fastening strap formed at the deflection element of the holder. The holder thus remains secured at the tube section of the two-wheeler even when the explained operative connection between the first end section and the second end section of the fastening strap (i.e. at the receiving section of the holder) is released, for example to remove the accessory or to adapt the mounting to another accessory.

In accordance with a further development, the support section of the holder can have a deflection web which deflects the intermediate section of the fastening strap in the direction of the named deflection element. The deflection element can also be formed integrally, i.e. in one piece, at the holder. A suitable leading of the fastening strap is thus made possible in a simple manner in the region of the support section of the holder.

The cooperation of the deflection element and of the deflection web for forming a loop of the fastening strap and the further operative connection at the loop engaging around the tube section allow a reliable fastening of the holder to the tube section of the two-wheeler in a particularly simple manner since no additional components are required (such as separate eyelets). The deflection element and the deflection web can instead be formed integrally at the holder and only the further operative section and the associated further operative counter-section have to be provided at the fastening strap.

The named deflection web can, together with a boundary web of the support section, bound a circumferentially closed passage opening through which the fastening strap is led. A reliable guiding of the fastening strap in all directions hereby results.

In accordance with a further advantageous embodiment, the support section of the holder has an entry opening and an exit opening spaced apart therefrom, wherein the intermediate section of the fastening strap is led through the entry opening, engages around the tube section of the two-wheeler, starting from said entry opening, and is led through the exit opening without any further deflection. A particularly simple extent of the fastening strap is hereby made possible which is also easily intuitively understandable for the user. Furthermore, a two-wheeler accessory can be secured at a tube section with a particularly large diameter as long as the fastening strap has a sufficient length.

It is of advantage with respect to all of the aforesaid embodiments if the holder has at least one pair of elevated guide portions which project from an outer surface of the receiving section of the holder and secure the fastening strap against a lateral sliding, i.e. against a sliding transversely to the longitudinal direction of extent of the fastening strap. The elevated guide portions are preferably spaced apart from one another corresponding to the width of the fastening strap and extend in parallel with one another. The elevated guide portions can be formed, for example, by tongues, webs and ribs which are shaped at the holder.

Finally, the invention also relates to a two-wheeler accessory (e.g. a two-wheeler lock) having a holder of the explained kind.

### BRIEF DESCRIPTION OF THE DRAWINGS

The invention will be explained only by way of example in the following with reference to the drawings. Elements which are the same or of the same kind are marked by the same reference numerals therein.

FIG. 1 shows a perspective view of a mounting in accordance with a first embodiment;

FIG. 2 shows a corresponding perspective view of a holder of the mounting without a fastening strap:

FIG. 3 shows a further perspective view of the holder;

FIG. 4 shows a corresponding perspective view of only the holder;

FIG. 5 shows a further perspective view of the holder;

FIG. 6 shows a cross-sectional view of the mounting which allows the extent of the fastening strap to be recognized;

FIG. 7 shows a corresponding cross-sectional view of a second embodiment; and

FIG. 8 shows a corresponding cross-sectional view of a third embodiment.

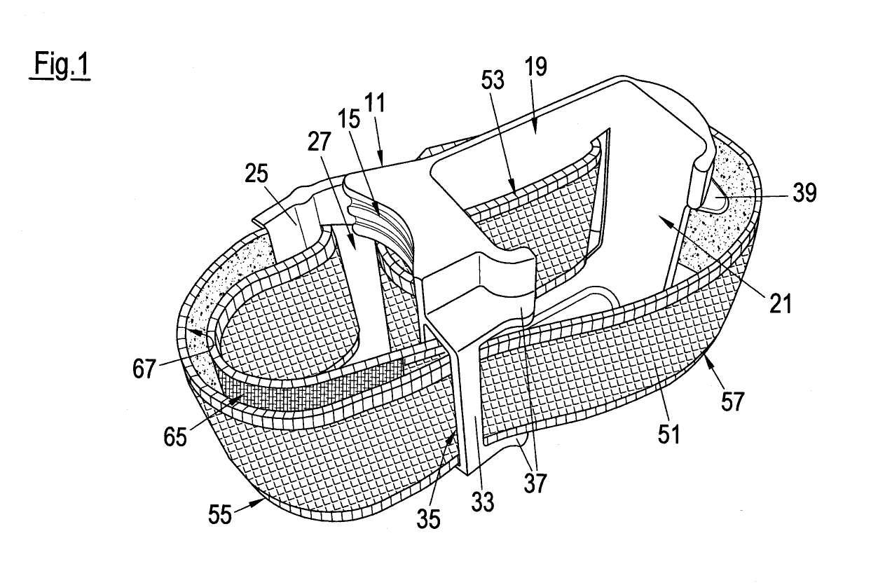

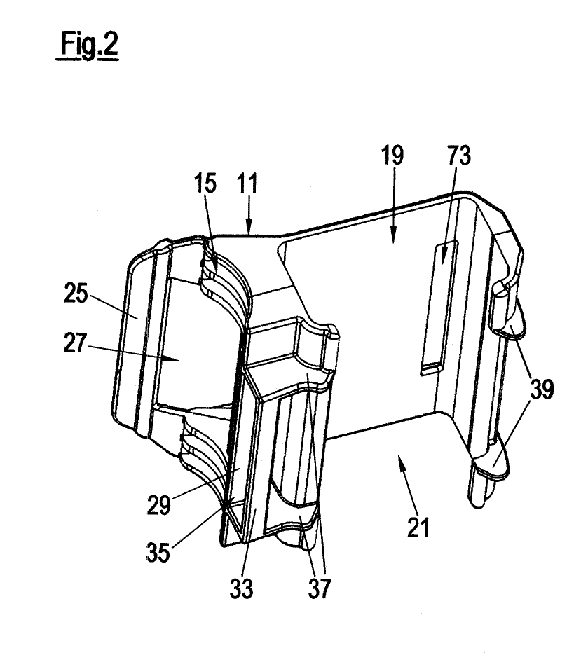

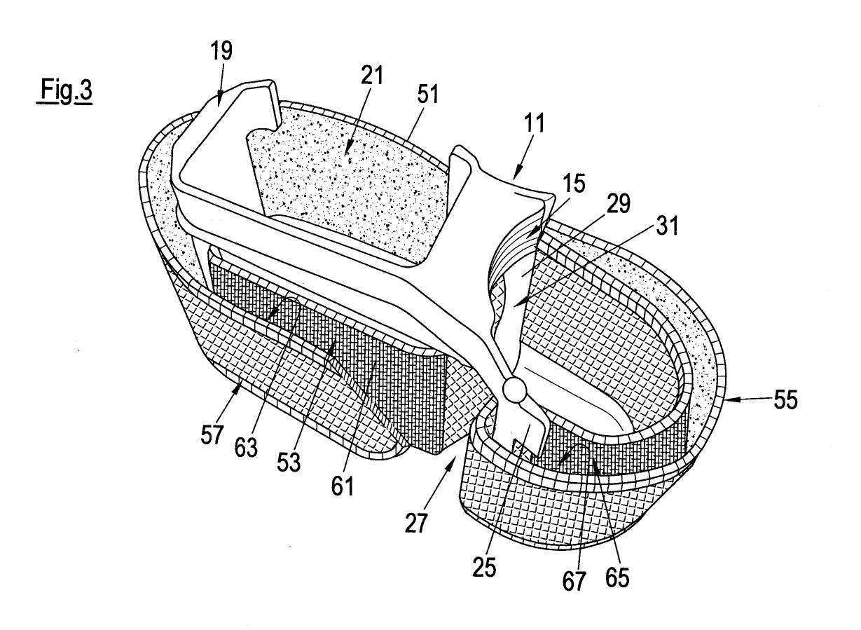

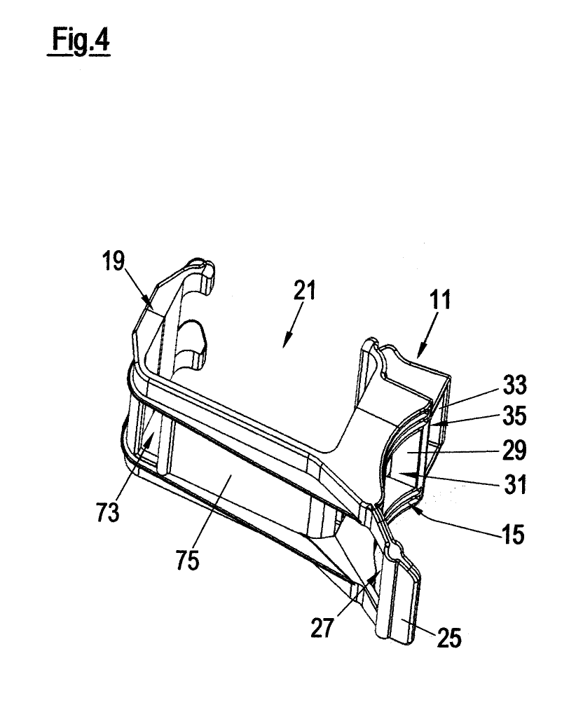

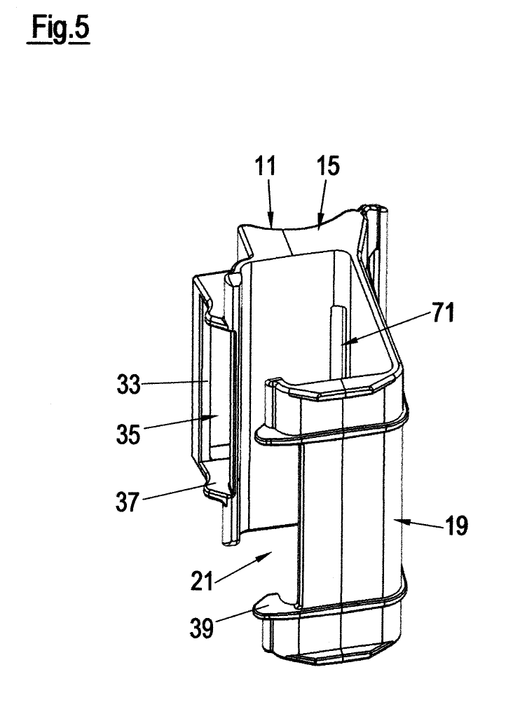

The mounting shown in FIGS. 1 to 6 comprises a holder 11 and a fastening strap 51. The holder 11 has a support section 15 which rests on a tube section 17 of a two-wheeler on a use of the mounting in accordance with its intended purpose. The support section 15 is concavely arched at its side facing the tube section 17 and can be provided with an integrated or separate rubber portion or the like to increase the friction and to prevent a sliding of the holder 11 along the tube section 17. Furthermore, ribs can be provided at the support section 15, as is described in the document DE 20 2005 013 390 U1. The holder 11 furthermore has a receiving section 19 which defines a receiving opening 21 for receiving a two-wheeler accessory 23.

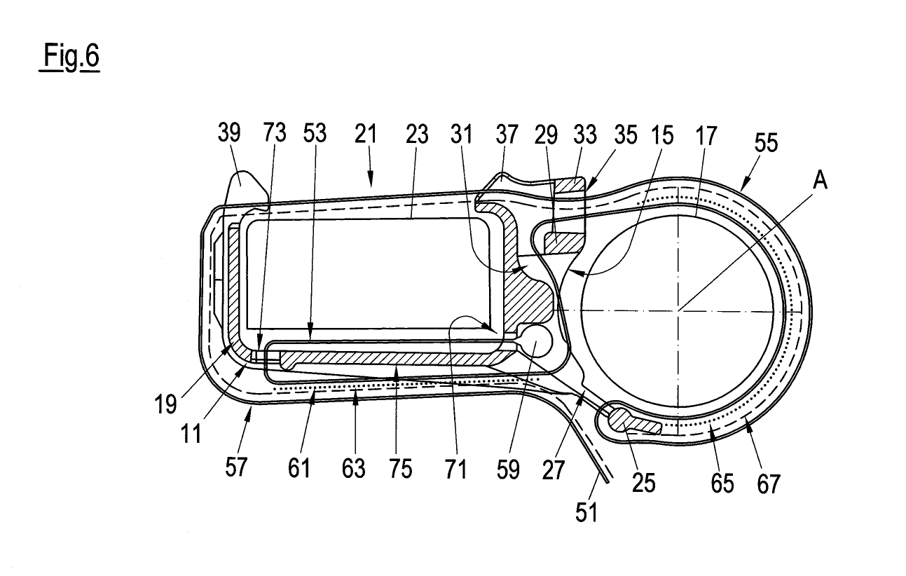

In the embodiment shown here, the holder 11 is formed by a single plastic part, i.e. the support section 15 and the receiving section 19 are formed integrally at the holder 11. The receiving section 19 substantially has a C shape within the plane shown in FIG. 6, i.e. in a plane perpendicular to the axis A of the tube section 17, with a limb of the C shape corresponding to the support section 15. The open side of the C shape is arranged laterally here with respect to an imaginary connection line between the center of the tube section 17 (axis A) and the center of the received accessory 23. Such an alignment of the open side of the receiving section 19 is advantageous since the accessory 23 can hereby be particularly reliably clamped. The receiving section 19 could, however, generally also be open at the side remote from the support section 15, with the receiving section 19 substantially being able to have a C shape or U shape (similar to the mounting in accordance with document U.S. Pat. No. 5,833,188). Alternatively, the receiving section 19 could be circumferentially closed (similar to the mounting in accordance with document DE 20 2005 013 390 U1).

In the embodiment shown here, the holder 11 further comprises a deflection element 25 which is formed integrally at the holder 11 in a transition region between the support section 15 and the receiving section 19. The deflection element 15 extends in parallel with the axis A of the tube section of the two-wheeler so that a first passage opening 27 is formed between the deflection element 25, on the one hand, and the support section 15 and the receiving section 19, on the other hand.

The holder 11 moreover comprises a deflection web 29 at the support section 15 which web likewise extends in parallel to the axis A of the tube section 17 of the two-wheeler. A second passage opening 31 is formed between the deflection web 29 and the support section 15 of the holder 11. The holder 11 furthermore also comprises a boundary web 33 at the support section 13 which boundary web extends adjacent to and in parallel with the deflection web 29 and bounds a third passage opening 35 together with the deflection web 29.

Finally, the holder 11 comprises a first pair of outwardly laterally projecting, mutually spaced apart elevated guide portions 37 at the support section 15 adjacent to the boundary web 33. At the receiving section 19, the holder 11 has a second pair of outwardly laterally projecting, mutually spaced apart elevated guide portions 39. The elevated guide portions 39 are tongue-shaped at the end of the corresponding limb of the C shape of the receiving section 19 and merge into webs which extend along the receiving section 19 within a plane in each case which extends perpendicular to the axis A of the tube section 17 of the two-wheeler.

The fastening strap 51 is, when the mounting is secured to the tube section 17 of the two-wheeler in accordance with its intended purpose and when the two-wheeler accessory 23 is inserted into the mounting, led around the tube section 17 and the two-wheeler accessory 23.

The fastening strap 51 is a flexible fabric strap made of plastic. It comprises a first end section 53 which is provided in the region of the receiving section 19 of the holder 11 in the explained extent of the fastening strap 51. The fastening strap 51 furthermore comprises an intermediate element 55 which adjoins the first section 53 and which is provided in the region of the support section 15 of the holder 11 in the explained extent of the fastening strap 51. The fastening strap 51 furthermore comprises a second end section 57 which adjoins the intermediate section 55 and which is in turn provided in the region of the receiving section 19 of the holder 11 in the explained extent of the fastening strap 51. The fastening strap 51 has a thickened portion 59 at the first end section 53.

The fastening strap 51 has a first operative hook and loop section 61 (shown dotted in FIG. 6) along a part of the first end section 53. An associated first hook and loop counter-section 63 is provided along a part of the second end section 57 of the fastening strap 51 (shown dashed in FIG. 6). The fastening strap 51 furthermore comprises in the embodiment shown in FIGS. 1 to 6 a second operative hook and loop section 65 (shown dotted in FIG. 6) and an associated second hook and loop counter-section 67 (shown dashed in FIG. 6) which are provided along a respective part of the intermediate section 57 of the fastening strap 51, namely adjacent to the deflection element 25 of the holder 11.

The extent of the fastening strap 51 will now be explained in more detail with reference to FIG. 6. In the representation in accordance with FIG. 6, the axis A of the tube section 17 of the two-wheeler extends perpendicular to the sectional plane.

The thickened portion 59 at the first end section 53 of the fastening strap 51 is hung in at an anchorage opening 71 of the support section 15 of the holder 11. The first end section 53 first extends up to an exit opening 73 at the receiving section 19 of the holder 11. On the other side of the exit opening 73, the first end section 53 of the fastening strap 51 extends along an outer surface 75 of the receiving section 19 up to the first passage opening 27. The named outer surface 75 of the receiving section 19 supports the rear side of the first end section 53 of the fastening strap 51 in the region of the first operative hook and loop section 61.

On the other side of the first passage opening 27, the intermediate section 55 of the fastening strap 51 extends along the support section 15 of the holder 11 up to the second passage opening 31 through it and up to the third passage opening 35. The fastening strap 51 exits the holder 11 through the third passage opening 35 and extends up to the deflection element 25 to engage around the tube section 17 of the two-wheeler. The intermediate section 55 of the fastening strap 51 forms a loop (deflection by approx. 180°) at the deflection element 25 of the holder 11, i.e. starting from the deflection element 25, the fastening strap 51 extends back to the third passage opening 35 of the support section 15. Starting from this, the second end section 57 of the fastening strap 51 engages around the receiving section 19 of the holder 11 and thus the two-wheeler accessory 23 received therein such that the second end section 57 of the fastening strap 51 comes to lie on the first end section 53 of the fastening strap 51 along the named outer surface 75 of the receiving section 19.

It must be noted that the first hook and loop counter-section 63 of the second end section 57 of the fastening strap 51 comes to lie on the first operative hook and loop section 61 of the first end section 53 of the fastening strap 51 without a deflection. For this purpose, the first operative hook and loop section 61 and the first hook and loop counter-section 63 are located on different sides of the fastening strap 51 (the first operative hook and loop section 61 on the outer side, the first hook and loop counter-section 63 on the inner side).

The elevated guide portions 37, 39 in this respect secure the fastening strap 51 against a lateral slipping, i.e. against a slipping along the axis A of the tube section 17 of the two-wheeler.

The first operative hook and loop section 61 and the first hook and loop counter-section 63 thus form a first hook and loop connection along the named outer surface 75 of the receiving section 19 of the holder 11. Adjacent to the deflection element 25 of the holder 11, i.e. along a part of the periphery of the tube section 17 of the two-wheeler, the second operative hook and loop section 65 and the second hook and loop counter-section 67 of the fastening strap 51 form a second hook and loop connection.

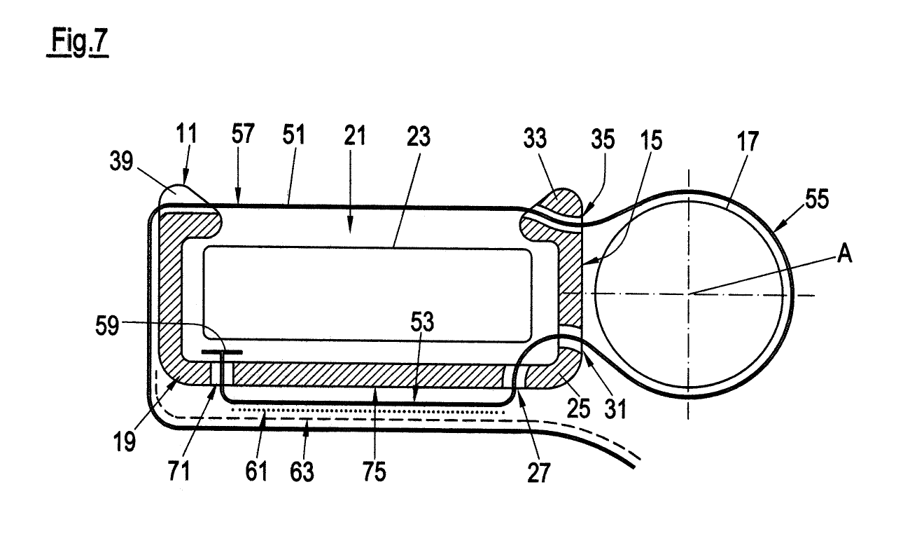

FIG. 7 shows a second embodiment of a mounting with a simpler structure in a cross-sectional view corresponding to FIG. 6. Unlike the first embodiment, no additional deflection of the fastening strap 51 (loop) is provided in the region of the tube section 17 of the two-wheeler. The thickened portion 59 of the fastening strap 51 is furthermore anchored at a different point.

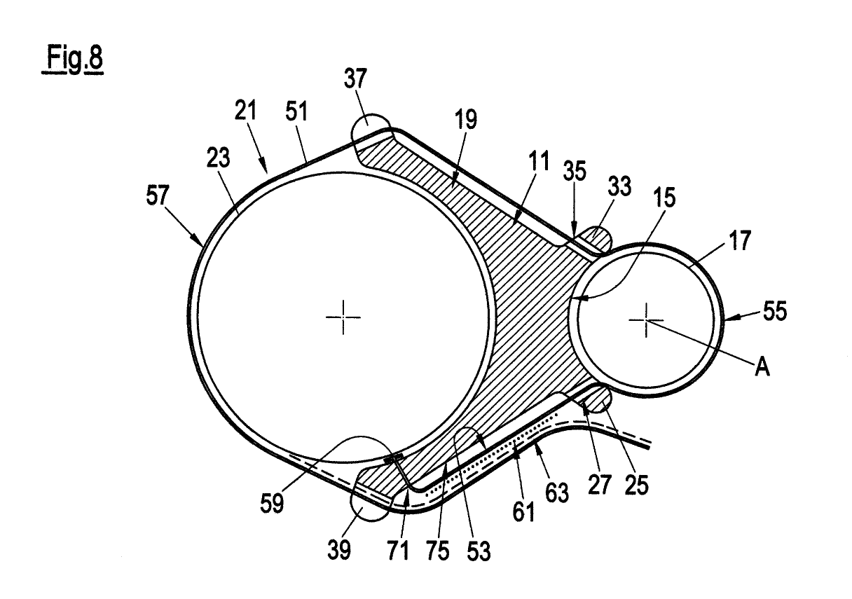

FIG. 8 shows a corresponding cross-sectional view of a third embodiment of a mounting. The mounting in accordance with FIG. 8 is structured in a similar manner to the mounting in accordance with FIG. 7, wherein the receiving section 19 of the holder 11 is essentially of U shape here.

In the three embodiments shown here, the first end section 53 of the fastening strap 51 is directly connected to the second end section 57 via a hook and loop connection (first operative hook and loop section 61 and first hook and loop counter-section 53). The holder 11, the tube section 17 of the two-wheeler and the two-wheeler accessory 23 are hereby fixed together to one another. The position of the first end section 53 of the fastening strap 51 is fixed in the region of the receiving section 19 of the holder 11, i.e. the position of the first end section 53 of the fastening strap 51 is independent of the size (e.g. diameter) of the tube section 17 of the two-wheeler and of the received two-wheeler accessory 23.

The advantage results in the shown mountings that it can be ensured even when used for different sizes (e.g. diameters) of the tube section 17 of the two-wheeler and of the two-wheeler accessory 23 that the first operative hook and loop section 61 and the associated first hook and loop counter-section 63 always overlap sufficiently to form a reliable hook and loop connection. It can be seen from FIGS. 6, 7 and 8 that the first operative hook and loop section 61 of the fastening strap 51 fixed with respect to its position at the holder 11 would also be completely covered by the associated first hook and loop counter-section 63 in the event of a larger or smaller diameter of the tube section 17 of the two-wheeler and of the two-wheeler accessory 23. The first hook and loop counter-section 63 is namely longer than the first operative hook and loop section 61 and would only change its relative position to the first operative hook and loop section 61 whose position is unchangeably fixed at the receiving section 19. The first hook and loop counter-section 63 thus only has to be provided along a sufficiently large part of the second end section 57 of the fastening strap 51.

It is in contrast avoided that the first operative hook and loop section 61 and the associated first hook and loop counter-section 63 are provided directly adjacent to one another at the fastening strap 51 (in particular both at the first end section 53 or both at the second end section 57 of the fastening strap 51). Such an embodiment admittedly allows the simple formation of a loop for the mutual contacting of the two associated hook and loop sections 61, 63 (e.g. by folding over the fastening strap 51 at an eyelet). However, the problem also results with such an embodiment that with different sizes of the tube section 17 which is engaged around and of the two-wheeler accessory 23, a relative displacement of the first operative hook and loop section 61 and of the associated first hook and loop counter-section 63 occurs which results directly in a smaller degree of overlap of the two hook and loop sections 61, 63. This problem admittedly generally also arises with respect to the second operative hook and loop section 65 and to the associated hook and loop counter-section 67 in accordance with FIG. 6. However, the loop formation at the deflection element 25 in the first embodiment in accordance with FIGS. 1 to 6 does not have the result that the degree of overlap between the first operative hook and loop section 61 and the associated first hook and loop counter-section 63 is reduced which ultimately ensure the fastening of the two-wheeler accessory 23 at the tube section 17 of the two-wheeler due to their arrangement at the two end sections 53, 57 of the fastening strap 51.

A further advantage of the shown mountings is that all hook and loop sections 61, 63, 65, 67 are provided at the fastening strap 51. An inexpensive production of the respective mounting hereby results since only the fastening strap 51 has to be provided with hook and loop sections (or other operative sections), which can be done in a simple manner, for example, by sewing on. Furthermore, no additional eyelets are required (such as with the mounting in accordance with the document U.S. Pat. No. 5,833,188, for example), but the required deflection of the fastening strap 51 can rather take place on the basis of integral sections of the holder 11 (e.g. deflection element 35, deflection web 29). The mounting only requires a single plastic part (holder 11) and a fastening strap 51 matched thereto.

### REFERENCE NUMERAL LIST

11 holder

15 support section

17 tube section

19 receiving section

21 receiving opening

23 two-wheeler accessory

25 deflection element

27 first passage opening

29 deflection web

31 second passage opening

33 boundary web

35 third passage opening

37 elevated guide portion

39 elevated guide portion

51 fastening strap

53 first end section

55 intermediate section

57 second end section

59 thickened portion

61 first operative hook and loop section

63 first hook and loop counter-section

65 second operative hook and loop section

67 second hook and loop counter-section

71 anchorage opening

73 exit opening

75 outer surface

A axis of the tube section

1. A mounting for a two-wheeler accessory (23), such as for a two-wheeler lock, for a water bottle or the like,
having a holder (11) which comprises a support section (15) for resting on a tube section (17) of a two-wheeler and a receiving section (19) for receiving the two-wheeler accessory (23); and
having a fastening strap for fastening the holder (11), the tube section (17) and the two-wheeler accessory (23) to one another,
wherein the fastening strap has at least one operative section (61) and one associated operative counter-section (63) which forms a releasable operative connection with the operative section to define the position of the fastening strap, and wherein the fastening strap has a first end section (53), a second end section (57) and at least one intermediate section (55) disposed therebetween,
wherein the first end section (53) of the fastening strap (51) extends in the region of the receiving section (19) of the holder, the intermediate section (55) of the fastening strap extends in the region of the support section (15) of the holder and the second end section (57) of the fastening strap in turn extends in the region of the receiving section (19) of the holder, wherein the operative section (61) of the fastening strap is provided along a part of the first end section and the associated operative counter-section (63) is provided along a part of the second end section (57) of the fastening strap.

2. A mounting in accordance with claim 1,
wherein the receiving section (19) of the holder (11) is open along an axis parallel to the axis (A) of the tube section (17) of the two-wheeler, with the receiving section (19) of the holder (11) being circumferentially open.

3. A mounting in accordance with claim 1,
wherein the fastening strap (51) extends in a plane perpendicular to the axis (A) of the tube section (17) of the two-wheeler and engages around the tube section (17) of the two-wheeler and around the two-wheeler accessory (23).

4. A mounting in accordance with claim 1,
wherein the receiving section (19) of the holder (11) has a C shape or a U shape in a plane perpendicular to the axis (A) of the tube section (17), said C shape or U shape being laterally open with respect to a connection line between the center of the tube section (17) and the center of the two-wheeler accessory (23).

5. A mounting in accordance with claim 1,
wherein the position of the first end section (53) of the fastening strap (51) is fastened with the operative section (61) provided thereat independently of the size of the tube section (17) of the two-wheeler and of the two-wheeler accessory (23).

6. A mounting in accordance with claim 1,
wherein the operative section (61) of the fastening strap (51) is formed by an operative hook and loop section and the associated operative counter-section (63) of the fastening strap is formed by a hook and loop counter-section, with the operative hook and loop section and the associated hook and loop counter-section forming a hook and loop connection.

7. A mounting in accordance with claim 1,
wherein the fastening strap (51) has an anchor (59) at the first end section (53), with the holder having an anchorage opening (71) through which the fastening strap is led, with the anchor (59) contacting a boundary of the anchorage opening (71) such that the first end section (53) of the fastening strap is fastened to the holder (11).

8. A mounting in accordance with claim 1,
wherein the first end section (53) of the fastening strap (51) is led along an outer surface (75) of the receiving section (19) of the holder (11); wherein the intermediate section (55) of the fastening strap is led around the tube section (17) of the two-wheeler such that the tube section of the two-wheeler is pressed toward the support section (15) of the holder by exertion of a pulling force on the fastening strap; and wherein the second end section (57) of the fastening strap is in turn led along the outer surface (75) of the receiving section (19) of the holder such that the operative counter-section (63) of the fastening strap comes to lie on the associated operative section (61) of the fastening strap.

9. A mounting in accordance with claim 1,
wherein the holder furthermore has a deflection element (25) which projects from the support section (15) or from the receiving section (19) and which is adapted to receive a loop formed by the intermediate section (55) of the fastening strap (51) when the fastening strap engages around the tube section (17) of the two-wheeler.

10. A mounting in accordance with claim 9,
wherein the fastening strap (51) has a further operative section (65) and an associated further operative counter-section (67) which forms a further releasable operative connection with the further operative section to define the loop of the fastening strap (51) formed at the deflection element (25) of the holder.

11. A mounting in accordance with claim 9,
wherein the support section (15) of the holder (11) has a deflection web (29) which deflects the intermediate section (55) of the fastening strap (51) in the direction of the deflection element (25).

12. A mounting in accordance with claim 11,
wherein the deflection web (29) bounds, together with a boundary web (33) of the support section, a circumferentially closed passage opening (35) through which the fastening strap (51) is led.

13. A mounting in accordance with claim 1,
wherein the support section (15) of the holder has an entry opening (27) and an exit opening (35) spaced apart herefrom, with the intermediate section (55) of the fastening strap (51) being led through the entry opening (27), engaging around the tube section (17) of the two-wheeler starting form this and being led through the exit opening (35) without any further deflection.

14. A mounting in accordance with claim 1,
wherein the holder (11) has at least one pair of elevated guide portions (37, 39) which project from an outer surface of the receiving section (19) of the holder (11) and secure the fastening strap (51) against a lateral slipping.

15. A mounting in accordance with claim 1,
wherein the position of the first end section (53) of the fastening strap (51) with the operative section (61) provided thereat is fixed unchangeably to the receiving section (19) of the holder (11) so that the position of the first end section (53) of the fastening strap (51) with the operative section (61) provided thereat not changing for different sizes of the tube section (17) of the two-wheeler and of the two-wheeler accessory (23).

16. A mounting in accordance with claim 15,
wherein the receiving section (19) of the holder (11) has a C shape or a U shape in a plane perpendicular to the axis (A) of the tube section (17), said C shape or U shape having a base and two limbs, with the first end section (53) of the fastening strap (51) with the operative section (61) provided thereat being arranged at one of the limbs or at the base of the C-shaped or U-shaped receiving section (19) of the holder (11).

17. A mounting in accordance with claim 15,
wherein the receiving section (19) of the holder (11) has a C shape or a U shape in a plane perpendicular to the axis (A) of the tube section (17), said C shape or U shape having a base and two limbs, with one of the limbs simultaneously forming the support section (15) of the holder (11) so that the C-shaped or U-shaped receiving section (19) has a lateral opening;
wherein the first end section (53) of the fastening strap (51) is arranged with the operative section (61) provided thereat at the base of the C-shaped or U-shaped receiving section (19) of the holder (11), with the intermediate section (55) of the fastening strap being led around the tube section (17) of the two-wheeler such that the tube section of the two-wheeler is pressed toward the support section (15) of the holder by exertion of a pulling force onto the fastening strap, and with the second end section (57) of the fastening strap in turn being led along the base of the C-shaped or U-shaped receiving section (19) of the holder (11) such that the lateral opening of the C-shaped or U-shaped receiving section (19) is closed and the operative counter-section (63) of the fastening strap comes to lie on the associated operative section (61) of the fastening strap.

18. A two-wheeler accessory (23) comprising a mounting in accordance with claim 1.
